(19) United States
(12) Patent Application Publication
(10) Pub. No.: US 2024/0161086 A1
(43) Pub. Date: May 16, 2024

(54) Multi-Computer System for Merchant-Integrated Cash Withdrawal

(71) Applicant: Bank of America Corporation, Charlotte, NC (US)

(72) Inventors: Manu Kurian, Dallas, TX (US); Kumarakuruparan Moorthy, Neelangaral (IN)

(21) Appl. No.: 17/986,963

(22) Filed: Nov. 15, 2022

(51) Int. Cl. G06Q 20/32; G06Q 20/10; G06Q 20/38

(52) U.S. Cl. CPC G06Q 20/3223; G06Q 20/10; G06Q 20/3267; G06Q 20/3274; G06Q 20/389

(57) ABSTRACT

Arrangements for providing merchant-integrated cash withdrawal functions are provided. A request to withdraw an amount of cash may be received. In response to receiving the request, an application programming interface (API) call may be initiated to one or more merchant systems to obtain funds availability from the merchant systems. Funds availability may be received from the merchant systems and a user interface may be generated including at least one merchant system having sufficient funds to provide the requested cash to the requesting user. The user interface may be transmitted to the user computing device and selection of a merchant system to complete the transaction may be received. In response to receiving the selection, a machine-readable code may be generated and transmitted to the user computing device. The code may be scanned, the amount of cash may be dispensed to the user and a user account may be debited.

### BACKGROUND

Aspects of the disclosure relate to electrical computers, systems, and devices for providing merchant-integrated cash withdrawal functions.

Enterprise organizations, such as financial institutions, often provide cash withdrawal services to customers via branch locations, self-service kiosks such at automated teller machines (ATMs) and the like. However, it can be difficult to locate branch locations and self-service kiosks in all customer locations. Accordingly, aspects described herein leverage merchants located in various geographic areas to provide merchant-integrated withdrawal capabilities to customers in areas that may be, for instance, without access to a branch location or self-service kiosk.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing withdrawal functionality in areas without access to a financial institution.

In some aspects, a request to withdraw an amount of cash or funds may be received. In some examples, the request may be received via an application executing on a user computing device. In response to receiving the request to withdraw an amount of funds, an application programming interface (API) call may be initiated or executed to one or more merchant computing systems. The API call may be initiated or executed to obtain funds availability data from the one or more merchant computing systems.

In some examples, funds availability data may be received from the one or more merchant computing systems and a user interface may be generated. In some arrangements, the user interface may include at least one merchant computing system of the one or more merchant computing systems that has sufficient funds available to provide or dispense the requested cash or funds to the requesting user. The user interface may be transmitted to the user computing device and displayed on the user computing device.

In some examples, a user may select a merchant computing system from the user interface to complete the withdrawal transaction. In response to receiving user selection of a merchant computing system, a machine-readable code may be generated and transmitted to the user computing device.

Upon receiving an indication of a scan of the machine-readable code, the requested amount of funds may be dispensed to the requesting user, the user account may be debited in an amount corresponding to the amount of withdrawn funds and an account ledger may be updated.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing merchant withdrawal control functions in accordance with one or more aspects described herein;

FIGS. 2A-2H depict an illustrative event sequence for implementing merchant withdrawal control functions in accordance with one or more aspects described herein;

FIG. 3 illustrates an illustrative method for implementing merchant withdrawal control functions according to one or more aspects described herein;

FIG. 4 illustrates one example user interface that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, financial institutions often do not have branch locations or self-service kiosks, such as automated teller machines (ATMs), in all geographic areas. In conventional arrangements, in order to provide services, such as cash withdrawal services to customers in areas not having these facilities, the financial institution would have to build and maintain a branch location or ATM. This can be time intensive and inefficient. Accordingly, arrangements described herein are directed to leveraging merchants in various geographic locations without a branch location or ATM, to provide cash withdrawal services to customers.

For instance, a user may request a cash withdrawal via a mobile banking application executing on the user computing device. The request may include an amount of cash, an account from which to withdraw funds, and the like. In response, a computing platform may initiate one or more application programming interface (API) calls to one or more merchant computing systems (e.g., in an identified geographic location) to complete the withdrawal transaction and dispense the funds to the user. The API call may request funds availability data from the one or more merchant computing systems.

Funds availability data may be received from the one or more merchant computing systems and a user interface providing merchants having available funds may be generated and transmitted to the user computing device. For instance, the interface including merchants having available funds may be displayed via the mobile banking application. A user may select, from the user interface, a merchant to complete the transaction and a machine-readable code may be generated and transmitted to the user computing device. The machine-readable code may be used to complete the transaction.

Accordingly, the user may proceed to the merchant location, display the machine-readable code for scanning and an indication of scanning may be received by the computing platform. The computing platform may verify the scanning and cause the funds to be dispensed to the user. The user account may then be debited and an account ledger updated.

Upon detection of a settlement triggering event (e.g., close of business, time of day, or the like) all withdrawal transactions with a particular merchant may be settled and the funds dispensed to customers may be replaced in a merchant account. Accordingly, the merchant may be made whole for the funds dispensed to the user. In some examples, the merchant may be paid a fee for providing this service.

These and various other arrangements will be discussed more fully below.

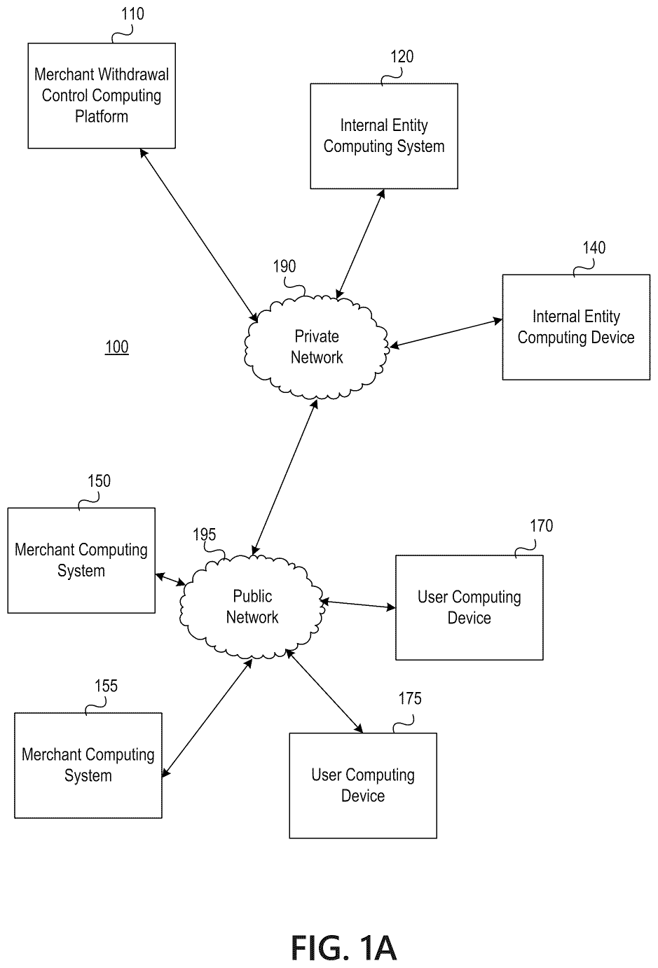

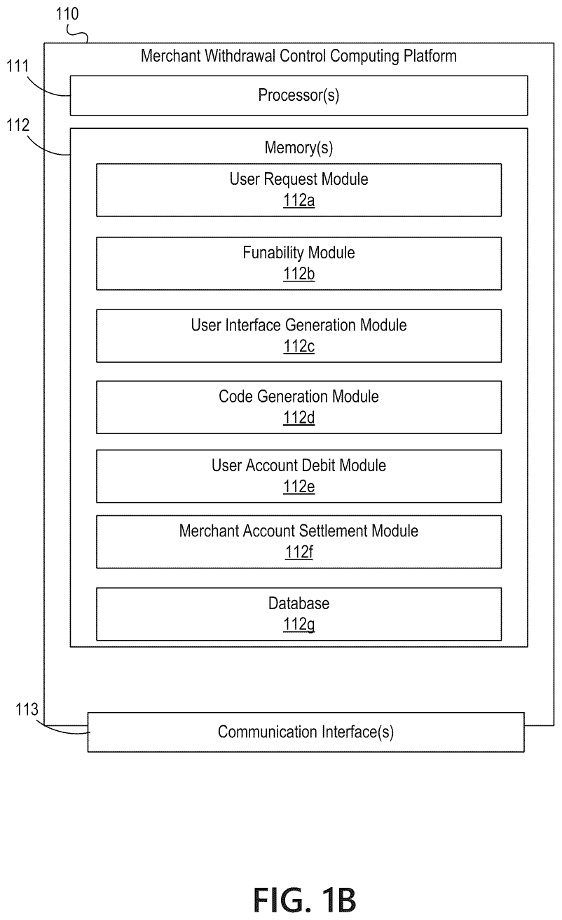

Aspects described herein may be implemented using one or more computing devices operating in a computing environment. For instance, FIGS. 1A-1B depict an illustrative computing environment for implementing merchant withdrawal control functions in accordance with one or more aspects described herein. Referring to FIG. 1A, computing environment 100 may include one or more computing devices and/or other computing systems. For example, computing environment 100 may include merchant withdrawal control computing platform 110, internal entity computing system 120, internal entity computing device 140, merchant computing system 150, merchant computing system 155, user computing device 170, and/or user computing device 175. Although one internal entity computing system 120, one internal entity computing device 140, two merchant computing systems 150, 155, and two user computing devices 170, 175 are shown, any number of systems or devices may be used without departing from the invention.

Merchant withdrawal control computing platform 110 may be configured to perform intelligent, dynamic, and efficient cash withdrawal functions via an interface between a financial institution and a merchant. In some examples, merchant withdrawal control computing platform 110 may receive, from an application executing on a user device, such as a mobile banking application, online banking application, or the like, a request to withdraw funds from a user account. The request to withdraw funds may include an amount of funds, an account from which the funds should be withdrawn, and the like. In response to receiving the request, the merchant withdrawal control computing platform 110 may initiate an application programming interface (API) call to one or more merchant systems (e.g., merchant computing system 150, merchant computing system 155, and the like) to assess fundability of the withdrawal. In some examples, the call may be initiated to one or more merchants within a geographic location or area selected by the requesting user, within a predetermined distance from a current location of the requesting user (e.g., based on global positioning system data received from the user device), or the like.

In response to the API call, merchant withdrawal control computing platform 110 may receive merchant response data indicating whether sufficient funds are available at a merchant location to fund the requested withdrawal. In response to receiving the funds availability data, merchant withdrawal control computing platform 110 may generate a user interface including one or more merchants available for selection. The generated user interface may be transmitted to the user device and displayed on a display of the user device (e.g., via the application).

Merchant withdrawal control computing platform 110 may receive user input selecting a merchant for the requested withdrawal. In response, the merchant withdrawal control computing platform 110 may flag the user account associated with the requested withdrawal and may generate a machine-readable code associated with the request. The merchant withdrawal control computing platform 110 may transmit the machine-readable code to the user device. The user may then present the machine-readable code for scanning at the merchant location.

Upon receiving an indication of the scan of the machine-readable code, merchant withdrawal control computing platform 110 may authorize distribution of the requested funds by the merchant and may update an account ledger of the user account based on the withdrawal. In some examples, a ledger associated with a merchant settlement account may be updated indicating that funds were disbursed from the merchant settlement account. The merchant withdrawal control computing platform 110 may then, upon detection of a triggering event, cause settlement of the merchant settlement account by, for instance, transferring funds from a financial institution account to the merchant settlement account.

Internal entity computing system 120 may be or include one or more computing devices or systems (e.g., servers, server blades, or the like) including one or more computer components (e.g., processors, memory, or the like) that may store account ledger data (e.g., user account ledger data, merchant settlement account ledger data, and the like), may track account transactions, and the like. In some examples, information identifier a user associated with one or more accounts may also be stored by the internal entity computing system 120.

Internal entity computing device 140 may be or include computing devices (e.g., laptop computing devices, desktop computing devices, tablet computing devices, mobile computing devices, and the like) operated by an enterprise organization associate (e.g., system administrator, or the like) to review transactions associated with the merchant withdrawal control computing platform 110, update registration requirements for users and merchants, and the like.

Merchant computing system 150 and/or merchant computing system 155 may be or include one or more computing devices or systems (e.g., servers, server blades, or the like) including one or more computer components (e.g., processors, memory, or the like) associated with one or more merchants (e.g., merchant entities external to or not associated with an enterprise organization implementing the merchant withdrawal control computing platform 110). In some examples, merchant computing system 150 and/or merchant computing system 155 may be associated with different merchant entities that have registered with the enterprise organization to participate in the merchant withdrawal program and have agreed to provide withdrawal functionality to customers of the enterprise organization. Merchant computing system 150 and/or merchant computing system 155 may be configured to receive API calls from merchant withdrawal control computing platform 110, provide availability of funds data to merchant withdrawal control computing platform 110, scan a machine-readable code from a user device, record funds dispensed, and the like.

User computing device 170 and/or user computing device 175 may be or include computing devices (e.g., laptop computing devices, desktop computing devices, tablet computing devices, mobile computing devices, and the like) owned or operated by one or more customers of the enterprise organization. In some examples, user computing device 170 and/or user computing device 175 may be devices configured to execute an application (e.g., mobile banking application, online banking application or portal, or the like) through which the user may request withdrawal of funds. User computing device 170 and/or user computing device 175 may also be configured to receive, store, display, and the like, a machine-readable code that may be used to retrieve the requested funds.

As mentioned above, computing environment 100 also may include one or more networks, which may interconnect one or more of merchant withdrawal control computing platform 110, internal entity computing system 120, internal entity computing device 140, merchant computing system 150, merchant computing system 155, user computing device 170 and/or user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, merchant withdrawal control computing platform 110, internal entity computing system 120, and/or internal entity computing device 140, may be associated with an enterprise organization (e.g., a financial institution), and private network 190 may be associated with and/or operated by the organization, and may include one or more networks (e.g., LANs, WANs, virtual private networks (VPNs), or the like) that interconnect merchant withdrawal control computing platform 110, internal entity computing system 120, and/or internal entity computing device 140, and one or more other computing devices and/or computer systems that are used by, operated by, and/or otherwise associated with the organization. Public network 195 may connect private network 190 and/or one or more computing devices connected thereto (e.g., merchant withdrawal control computing platform 110, internal entity computing system 120, internal entity computing device 140) with one or more networks and/or computing devices that are not associated with the organization. For example, merchant computing system 150, merchant computing system 155, user computing device 170 and/or user computing device 175, might not be associated with an organization that operates private network 190 (e.g., because merchant computing system 150, merchant computing system 155, user computing device 170 and/or user computing device 175 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect merchant computing system 150, merchant computing system 155, user computing device 170 and/or user computing device 175 to private network 190 and/or one or more computing devices connected thereto (e.g., merchant withdrawal control computing platform 110, internal entity computing system 120, internal entity computing device 140).

Referring to FIG. 1B, merchant withdrawal control computing platform 110 may include one or more processors 111, memory 112, and communication interface 113. A data bus may interconnect processor(s) 111, memory 112, and communication interface 113. Communication interface 113 may be a network interface configured to support communication between merchant withdrawal control computing platform 110 and one or more networks (e.g., private network 190, public network 195, or the like). Memory 112 may include one or more program modules having instructions that when executed by processor(s) 111 cause merchant withdrawal control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of merchant withdrawal control computing platform 110 and/or by different computing devices that may form and/or otherwise make up merchant withdrawal control computing platform 110.

For example, memory 112 may have, store and/or include user request module 112a. User request module 112a may store instructions and/or data that may cause or enable merchant withdrawal control computing platform 110 to receive one or more requests for withdrawals of funds (e.g., cash or currency) from, for instance, a merchant rather than an ATM or other self-service kiosk. The user request module 112a may receive the request and analyze the request to determine an amount of requested withdrawal, a user and/or user account from which the funds will be withdrawn, location data of the user, and the like.

Merchant withdrawal control computing platform 110 may further have, store and/or include fundability module 112b. Fundability module 112b may store instructions and/or data that may cause or enable merchant withdrawal control computing platform 110 to initiate an API call to one or more registered merchants to determine funds availability at each of the merchants. In some examples, user current location data may be used to identify one or more merchants to receive the API call. In some examples, the fundability module 112b may receive available funds response data from the one or more merchants.

Merchant withdrawal control computing platform 110 may further have, store and/or include user interface generation module 112c. User interface generation module 112c may store instructions and/or data that may cause or enable merchant withdrawal control computing platform 110 to generate one or more user interfaces for presentation to a user (e.g., via an application executing on user computing device 170). In some examples, the user interface may include selectable options associated with one or more merchants who are identified as having sufficient funds available for withdrawal in the amount requested.

Merchant withdrawal control computing platform 110 may further have, store and/or include code generation module 112d. Code generation module 112d may include instructions and/or data that may cause or enable merchant withdrawal control computing platform 110 to generate a machine-readable code (e.g., bar code, quick response (QR) code, or the like) that may be used to complete the withdrawal transaction. For instance, upon receiving selection of a merchant to complete the withdrawal (e.g., via a generated user interface), merchant withdrawal control computing platform 110 may generate a machine-readable code including data associated with authorizing the selected merchant, an amount of the withdrawal, an account from which funds should be withdrawn, identification of the user making the withdrawal, and the like. The machine-readable code may be transmitted to the user computing device 170 for display on the user computing device 170 and completion of the withdrawal.

Merchant withdrawal control computing platform 110 may further have, store and/or include user account debit module 112e. User account debit module 112e may store instructions and/or data that may cause or enable merchant withdrawal control computing platform 110 to earmark or flag (or generate an instruction causing internal entity computing system 120 to earmark or flag) a user account associated with the withdrawal. Further, user account debit module 112e may store instructions and/or data that may cause or enable the merchant withdrawal control computing platform 110 to withdraw funds from the user account (e.g., upon redemption via the machine-readable code), update an account ledger associated with the account, and the like.

Merchant withdrawal control computing platform 110 may further have, store and/or include merchant account settlement module 112f. Merchant account settlement module 112f may store instructions and/or data that may cause or enable the merchant withdrawal control computing platform 110 to execute a settlement function with a merchant system. For instance, merchant account settlement module 112f may detect a settlement triggering event and may cause funds disbursed by the merchant to be replaced (e.g., funds transferred to a merchant account) in order to settle the withdrawal transaction executed by the user. Accordingly, the merchant may be made whole and, in some examples, may collect a fee from the enterprise organization for facilitating the user or customer withdrawal.

Merchant withdrawal control computing platform 110 may further have, store and/or include a database 112g. Database 112g may store data related to withdrawal function history, merchant withdrawal transaction history, and the like. Additional data may be stored in database 112g without departing from the invention.

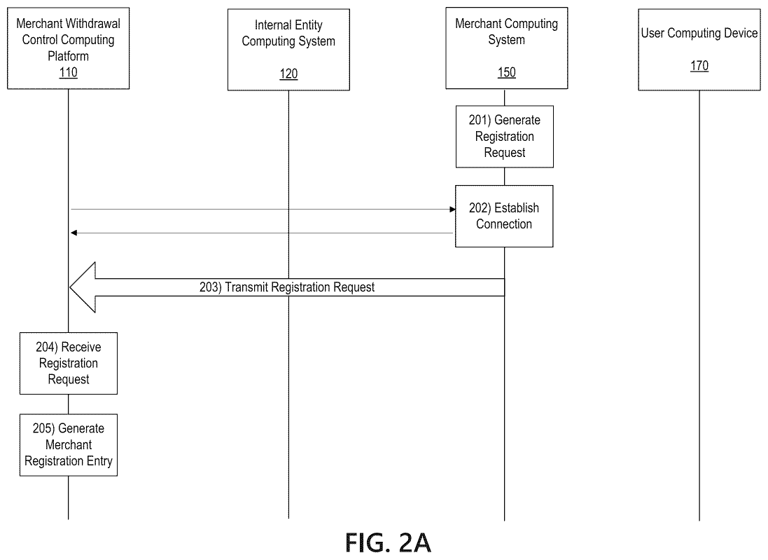

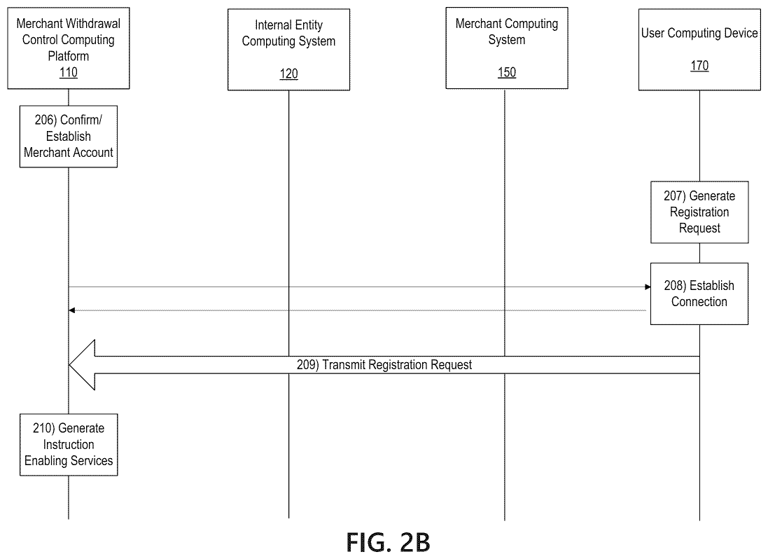

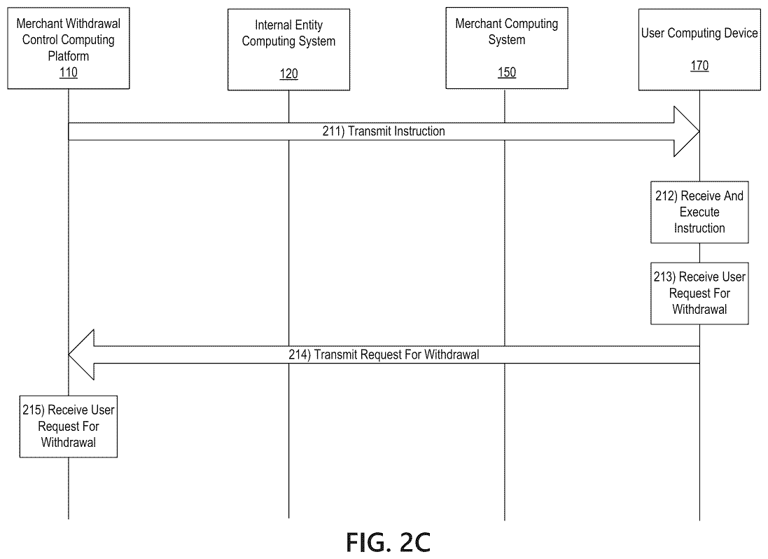

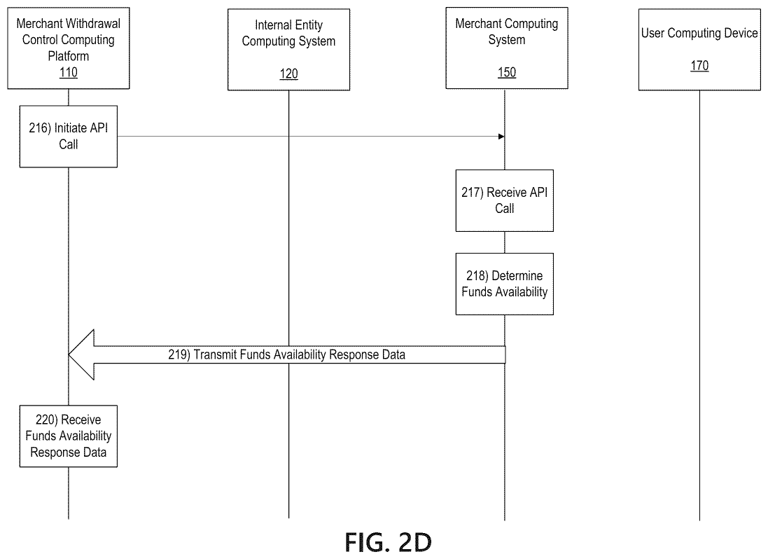

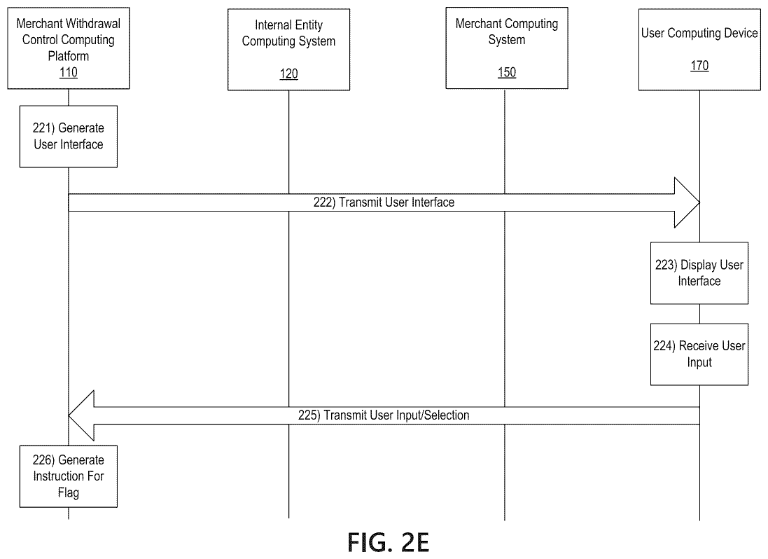

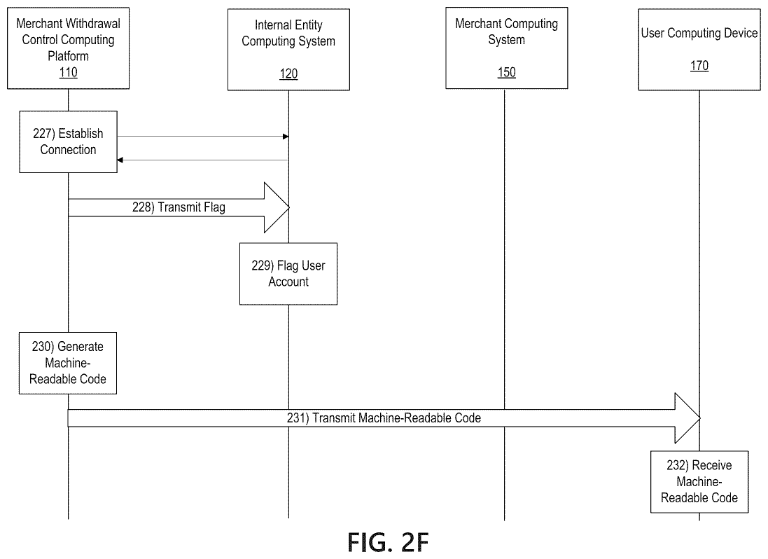

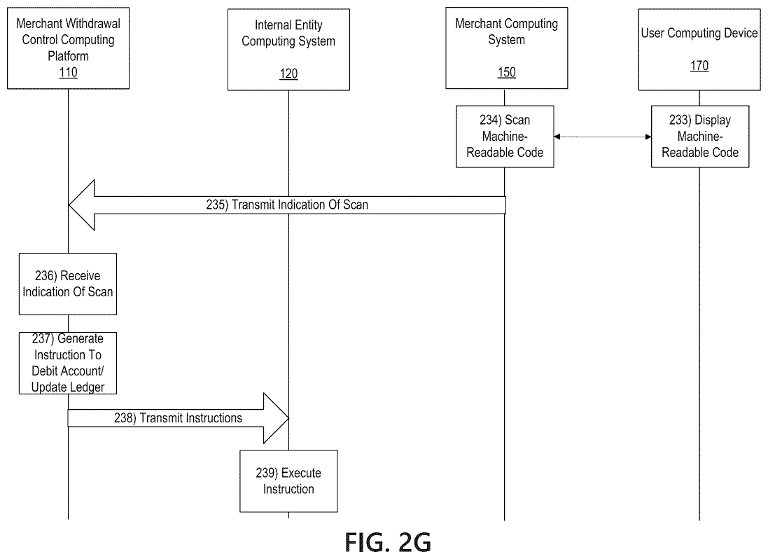

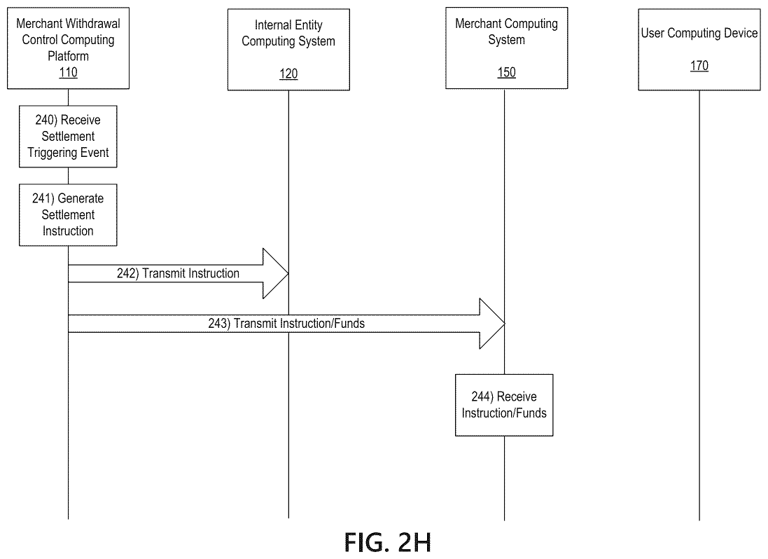

FIGS. 2A-2H depict one example illustrative event sequence for implementing merchant withdrawal control functions in accordance with one or more aspects described herein. The events shown in the illustrative event sequence are merely one example sequence and additional events may be added, or events may be omitted, without departing from the invention. Further, one or more processes discussed with respect to FIGS. 2A-2H may be performed in real-time or near real-time.

With reference to FIG. 2A, at step 201, merchant computing system 150 may generate a request to register with merchant withdrawal functionality provided by the enterprise organization. For instance, merchant computing system 150 may generate a request to register to provide merchant withdrawal functions to customers of the enterprise organization. In some examples, the request to register may include information identifying the merchant (e.g., tax or other identification number, location information, and the like) as well as information associated with an account of the merchant at the enterprise organization, if one has been established.

At step 202, merchant computing system 150 may connect to merchant withdrawal control computing platform 110. For instance, a first wireless connection may be established between merchant computing system 150 and merchant withdrawal control computing platform 110. Upon establishing the first wireless connection, a communication session may be initiated between merchant computing system 150 and merchant withdrawal control computing platform 110.

At step 203, merchant computing system 150 may transmit or send the request to register, and any associated data, to the merchant withdrawal control computing platform 110. For instance, the request to register may be transmitted or sent during the communication session initiated upon establishing the first wireless connection.

At step 204, merchant withdrawal control computing platform 110 may receive the request for registration and associated data.

At step 205, merchant withdrawal control computing platform 110 may generate a merchant registration entry. For instance, one or more systems, databases, or the like, may be updated to include the merchant as a merchant providing merchant withdrawal services.

With reference to FIG. 2B, at step 206, merchant withdrawal control computing platform 110 may confirm details of the merchant account held at the enterprise organization, if one has been established, or may open or establish a merchant account at the enterprise organization if one does not exist. For instance, a business account associated with the merchant may be verified or opened to permit settlement between the merchant and the enterprise organization. For instance, the merchant may provide funds to a user and may note the withdrawal. The enterprise organization may then execute a settlement function to transfer funds to the merchant account to make the merchant whole (e.g., repay the merchant for the funds distributed to the customer of the enterprise organization).

At step 207, user computing device 170 may generate a request to registration. For instance, a user may request, via an application executing on user computing device 170, to register for merchant withdrawal functions. In some examples, the request to register may include a preferred account of the user (e.g., checking account, savings account) for making withdrawals, any user preferences or limits on the withdrawals, one or more permissions to capture, for instance, location data of user computing device 170, and the like.

At step 208, user computing device 170 may connect to merchant withdrawal control computing platform 110. For instance, a second wireless connection may be established between user computing device 170 and merchant withdrawal control computing platform 110. Upon establishing the second wireless connection, a communication session may be initiated between user computing device and merchant withdrawal control computing platform 110.

At step 209, user computing device 170 may transmit or send the request for registration to the merchant withdrawal control computing platform 110. For instance, user computing device 170 may transmit or send the request to register during the communication session initiated upon establishing the second wireless connection.

At step 210, merchant withdrawal control computing platform 110 may receive the request for registration, may update user information and may generate an instruction enabling merchant withdrawal functions for the user computing device. For instance, an instruction to generate or update one or more interfaces, enable functionality, or the like may be generated.

With reference to FIG. 2C, at step 211, merchant withdrawal control computing platform 110 may transmit or send the generated instruction(s) to the user computing device 170. At step 212, user computing device 170 may receive and execute the generated instruction(s), which may cause the user computing device 170 to enable functionality (e.g., via the application), display one or more user interfaces (e.g., via the application), and the like.

At step 213, user computing device 170 may receive a user request for withdrawal of funds (e.g., a request to obtain cash funds). The request may be received via an enterprise organization application executing on user computing device (e.g., via a mobile banking application, an online banking application or portal, or the like). In some examples, the request may include an amount of funds to withdraw, an account from which the amount should be withdrawn (or identification or a predetermined preferred account for withdrawal) and the like.

At step 214, user computing device 170 may transmit or send the request for withdrawal to merchant withdrawal control computing platform 110. At step 215, merchant withdrawal control computing platform 110 may receive the request for withdrawal and any associated data.

With reference to FIG. 2D, at step 216, merchant withdrawal control computing platform 110 may initiate an API call to a merchant computing system 150 to determine an availability of funds at the merchant. Although FIG. 2D illustrates one API call to one merchant computing system 150, in some examples, an API call may be initiated to a plurality of merchant computing systems 150 associated with one or more different merchants. Further, in some examples, merchant withdrawal control computing platform 110 may receive current location data of user computing device 170 with the request for withdrawal and may identify one or more merchant computing systems 150 within a predetermined distance of the current location and may initiate API calls with the identified merchant systems.

At step 217, merchant computing system 150 may receive the API call. At step 218, an availability of funds at the merchant may be determined. For instance, the merchant computing system 150 may determine an amount of funds available to be distributed to customers of the enterprise organization for a particular time period (e.g., for the next hour, until close of business, through the next week, or the like).

At step 219, the determined amount of funds may be used to generated funds availability response data that may be transmitted by the merchant computing system 150 to the merchant withdrawal control computing platform 110. At step 220, merchant withdrawal control computing platform 110 may receive the funds availability response data.

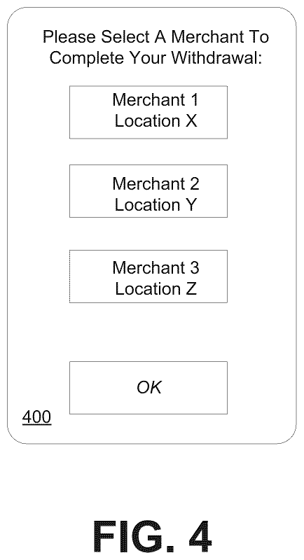

With reference to FIG. 2E, at step 221, merchant withdrawal control computing platform 110 may generate a user interface including one or more merchants having funds availability (e.g., based on received funds availability response data). In some examples, the user interface may be interactive and may include a selectable option associated with each merchant having available funds, may include location of each merchant, and the like. For instance, FIG. 4 illustrates one example user interface 400 that may be generated. The user interface identifies three merchants and associated locations. The user may select one of the merchants to complete the withdrawal and select “OK” option to process the selection. The user interface 400, number of merchants, and information provided are merely one example of a user interface that may be generated and the example shown does not limit the invention to only this user interface arrangement.

At step 222, merchant withdrawal control computing platform 110 may transmit the user interface to the user computing device 170. In some examples, transmitting the user interface may cause the user interface to display on a display of the user computing device 170.

At step 223, the user computing device 170 may receive the user interface and may display the user interface.

At step 224, user computing device 170 may receive user input selecting a merchant for funds withdrawal. At step 225, the user input selecting the merchant for funds withdrawal may be transmitted by the user computing device 170 to the merchant withdrawal control computing platform 110.

At step 226, merchant withdrawal control computing platform 110 may receive the user selection of the merchant and may generate a flag for the account of the user from which the funds will be withdrawn. For instance, a flag, earmark or the like, may be generated indicating that a withdrawal from the account is forthcoming or expected.

With reference to FIG. 2F, at step 227, merchant withdrawal control computing platform 110 may connect to internal entity computing system 120. For instance, a third wireless connection may be established between merchant withdrawal control computing platform 110 and internal entity computing system 120. Upon establishing the third wireless connection, a communication session may be initiated between merchant withdrawal control computing platform 110 and internal entity computing system 120.

At step 228, the merchant withdrawal control computing platform 110 may transmit or send the generated flag for the user account. For instance, the generated flag may be transmitted or sent during the communication session initiated upon establishing the third wireless connection.

At step 229, internal entity computing system 120 may receive the flag and associated instruction and may flag the user account. Accordingly, the flag may provide an indication to one or more other enterprise organization systems that a withdrawal from the account is forthcoming.

At step 230, merchant withdrawal control computing platform 110 may generate a machine-readable code. The machine-readable code may include a quick response (QR) code, bar code, or the like. In some examples, the machine-readable code may include information associated with an amount of the withdrawal, user of the withdrawal, account from which funds will be withdrawn, and the like.

At step 231, merchant withdrawal control computing platform 110 may transmit or send the machine-readable code to the user computing device 170. At step 232, user computing device 170 may receive the machine-readable code.

With reference to FIG. 2G, at step 233, receiving the machine-readable code may cause the user computing device 170 to store and/or display the machine-readable code. At step 234, the merchant computing system 150 may scan or read the machine-readable code from the display of the user computing device 170. For instance, the user may travel to the merchant location, display the machine-readable code for scanning and the merchant computing system 150 may scan the code to initiate and/or authorize the withdrawal. In some examples, one or more additional authentication factors may be provided (e.g., user identification, biometric data, username and personal identification number, or the like). In some arrangements, display of the machine-readable code via the application executing on the user computing device 170 (to which the user has logged in) may be sufficient authentication data to complete the withdrawal (e.g., no other authentication data may be required).

At step 235, merchant computing system 150 may transmit an indication of the scan of the machine-readable code to the merchant withdrawal control computing platform 110. At step 236, merchant withdrawal control computing platform 110 may receive the indication of the scan and may complete processing of the withdrawal.

For instance, at step 237, merchant withdrawal control computing platform 110 may generate an instruction to debit funds from the user account (e.g., the flagged account) and update an account ledger associated with the account and the withdrawal.

At step 238, the generated instruction may be transmitted by the merchant withdrawal control computing platform 110 to the internal entity computing system 120. At step 239, the internal entity computing system 120 may receive and execute the instruction, causing an account ledger to be updated and funds corresponding to the requested amount to be withdrawn from the user account. In some examples, those funds may be transferred to an enterprise organization holding account until settlement with the merchant. Additionally or alternatively, the funds may be transferred to the merchant account.

With reference to FIG. 2H, at step 240, merchant withdrawal control computing platform 110 may receive a settlement triggering event. For instance, one or triggering events may cause settlement between the enterprise organization and the merchant (e.g., the merchant may be reimbursed for the funds provided to the user on behalf of the enterprise organization, and/or any fees associated therewith). In some examples, settlement may occur after a predetermined time period has elapsed (e.g., after one hour, after 8 hours, or the like). Additionally or alternatively, settlement may occur at a predetermined time (e.g., close of business, 11:59 p.m., or the like). In some examples, settlement for all withdrawal transactions for one or more merchants may be performed at a same time (e.g., in one or more batch processes). Additionally or alternatively, settlement may occur upon completion of each withdrawal transaction. Accordingly, a settlement triggering event may include detection of the predetermined time period elapsing, detection of the predetermined time occurring, detection of completion of a transaction, or the like.

At step 241, based on the indication of the settlement triggering event, a settlement instruction may be generated. For instance, an instruction causing funds to be transferred to the merchant account associated with the withdrawal, updating of one or more account ledgers based on the transfer, and the like may be generated.

At step 242, the merchant withdrawal control computing platform 110 may transmit the instruction to the internal entity computing system 120 which may cause internal entity computing system 120 to transfer funds to the merchant account.

At step 243, the instruction and/or funds may be transferred to the merchant computing system 150. For instance, funds may be transferred to the merchant account and an indication of the transfer, record of the settlement, transfer of any associated fees, and the like, may be sent to the merchant computing system 150.

At step 244, the merchant computing system 150 may receive the instruction and/or funds which may cause the withdrawal record to be settled (e.g., the merchant was made whole for the funds provided to the customer of the enterprise organization).

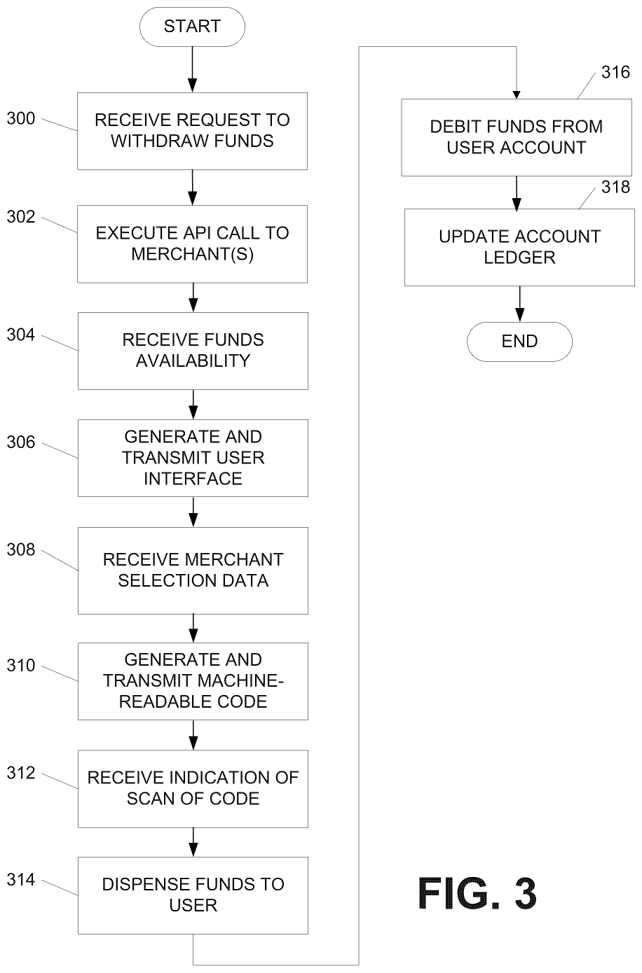

FIG. 3 is a flow chart illustrating one example method of implementing merchant withdrawal control functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a request to withdraw an amount of funds from a user account may be received. For instance, a merchant withdrawal control computing platform 110 may receive, via an application executing on a user computing device 170, a request to withdraw funds from a user account. In some examples, the user may be requesting to withdraw or obtain the funds in a cash disbursement.

At step 302, the merchant withdrawal control computing platform 110 may initiate or execute an application programming interface (API) call to one or more merchant computing systems to determine an availability of funds one or more merchant locations corresponding to the one or more merchant computing systems.

At step 304, the merchant withdrawal control computing platform 110 may receive funds availability response data from the one or more merchant systems. For instance, the merchant withdrawal control computing platform 110 may receive an indication of an amount of available funds, whether a merchant system has sufficient funds to dispense the requested amount of funds, or the like, from the one or more merchant computing systems.

At step 306, the merchant withdrawal control computing platform 110 may generate a user interface displaying at least one merchant system of the one or more merchant systems and/or a merchant associated with the at least one merchant system. The user interface may include at least one merchant system that has sufficient funds available to provide or dispense the amount of funds requested. In some examples, the user interface may be interactive and configured to receive user input selecting a merchant or merchant system to complete the withdrawal. The generated user interface may be transmitted to the user computing device 170. In some examples, transmitting the user interface may cause the user interface to display on a display of the user computing device 170.

At step 308, user input selecting a merchant or merchant computing system to complete the requested withdrawal may be received by the merchant withdrawal control computing platform 110. For instance, user input selecting an option provided via the generated user interface may be received.

At step 310, merchant withdrawal control computing platform 110 may generate a machine-readable code to complete the withdrawal transaction. For instance, merchant withdrawal control computing platform 110 may generate a machine-readable code including data related to the amount of the withdrawal, user associated with the withdrawal, merchant selected, and the like. The machine-readable code may be transmitted to the user computing device.

At step 312, the merchant withdrawal control computing platform 110 may receive an indication of a scan of the machine-readable code. For instance, the user may present the machine-readable code at the selected merchant computing system for scanning. An indication of the scan may be transmitted to the merchant withdrawal control computing platform 110 (e.g., an API call from the merchant computing system to the computing platform may be initiated) and may be verified (e.g., user verified, merchant verified, or the like).

In response to receiving (and/or verifying) the indication of the scan of the machine-readable code, at step 314, the merchant or merchant computing system may authorize and cause dispensing of the requested amount of funds to a user associated with the user computing device 170. For instance, an instruction authorizing the merchant or merchant computing system to provide cash in the amount of funds requested to the user based on scanning of the machine-readable code may be transmitting to the merchant computing system causing the merchant computing system to dispense the cash.

At step 316, the amount of funds may be debited from the user account and, at step 318, an account ledger associated with the user account may be updated. Accordingly, the user may receive funds via the merchant rather than from an ATM or other enterprise organization device or entity. The merchant may then execute a settlement process with the enterprise organization to settle the amount of funds dispensed (e.g., the merchant account may receive a transfer of funds equal to the amount of funds dispensed) and/or may receive one or more payments for providing the merchant withdrawal service to the user.

Accordingly, aspects described herein enable users or customers of an enterprise organization, such as a financial institution, to withdraw or obtain funds from, for instance, a merchant, when a financial institution branch or self-service kiosk is not available. Accordingly, the enterprise organization may provide the desired withdrawal services to customers without installing and maintaining self-service kiosks in additional geographic locations.

As discussed herein, the arrangements described leverage existing merchants in geographic locations that do not provide cash withdrawal services to customers of an enterprise organization or financial institution (e.g., areas that do not have a branch location of the financial institution, areas that do not have ATMs associated with the financial institution, or the like). In some examples, these arrangements may be used in areas having a branch and/or ATM but in order to provide additional cash withdrawal availability to users (e.g., without the maintenance of additional ATMs, network expansion, or the like).

Accordingly, arrangements described herein rely on merchants having, for instance, an existing location in a geographic area and engaging with the merchant to provide a merchant-integrated cash withdrawal function. Instead of obtaining cash from, for instance, an ATM, the user may stage the transaction via a mobile banking application on the user computing device and may pick up or obtain the cash from the merchant, rather than the financial institution. In order to provide this service, the merchant may engage with the financial institution, open or verify existence of an account with the financial institution, and the like.

The merchant system may then complete a settlement process with the financial institution to receive the funds disbursed to the user. For instance, the merchant computing system may provide to the computing platform a settlement report requesting funds to replace funds provided to, for instance, all users who used the merchant-integrated withdrawal function in a particular time period (e.g., 8 hour block, business day, calendar day, or the like).

The arrangements provided herein permit users to obtain cash withdrawals (e.g., withdraw money from the user's account at a financial institution via a merchant retail location. Accordingly, the merchant is not withdrawing money or charging the customer. Instead, the merchant is merely providing the funds (e.g., from funds taken in during the regular course of the merchant's business) that are debited from the user's account and will be made whole by the financial institution during the settlement process.

Further, by adding this functionality to an online banking portal or mobile banking application, the user may easily register for the service without any additional applications, logins, or the like. The user may simply execute withdrawals from their own account via a merchant location.

As discussed herein, in some examples, location data from the user computing device may be used to identify merchants to whom a request for funds availability may be transmitted. For instance, the user may provide, with permission, global positioning system data from the user device via the request for withdrawal. Additionally or alternatively, a user may input a desired location to complete the withdrawal. This position data may be used to identify the one or more merchant computing systems to initiate the API call requesting funds availability. In some examples, the user interface may include a map or other directions to one or more merchant locations, and/or may include a selectable option to initiate directions to a selected merchant location.

In receiving funds availability response data from the one or more merchants, in some examples, merchants may indicate yes or no whether sufficient funds are available. Additionally or alternatively, a merchant may indicate a limit on available funds (e.g., withdrawals up to $100, or the like). In some examples, the computing platform may identify more than one merchant for the user to obtain the requested amount of funds (e.g., $75 from Merchant A, $25 from Merchant B to complete a $100 withdrawal request).

In some examples, merchants desiring to participate in the merchant-integrated withdrawal process may complete an onboarding process. In some examples, the onboarding process may include opening a merchant account at the financial institution or verifying an account of the merchant at the financial institution. In some examples, a merchant profile may be generated based on the onboarding data received. In some examples, the merchant profile may include a limit on an amount of funds the merchant is willing to dispense (e.g., up to $500, up to $1000, or the like). In some examples, the merchant may also set up tiers of approval. For instance, withdrawals up to X amount may be automatically approved (e.g., if funds available) while withdrawals over X but below Y require one level of approval and requests over Y require a second, different level of approval.

Although aspects described herein generally rely on a user visiting a merchant or retail location to obtain funds, in some examples, the merchant may maintain a self-service kiosk at which the user can pick up funds. For instance, a self-service kiosk may be stationed at a location and, in some examples, may include lock boxes that may be opened upon scanning the machine-readable code. In some examples, the merchant may stock the kiosk with necessary funds (e.g., rather than the financial institution). This may enable the merchant to remain anonymous to the user while still providing funds to the user.

Further, in some examples, arrangements described herein may be used in cases of natural disasters or other emergency needs. For instance, a truck or kiosk may be set up including funds that may be dispensed via the systems and arrangements described herein.

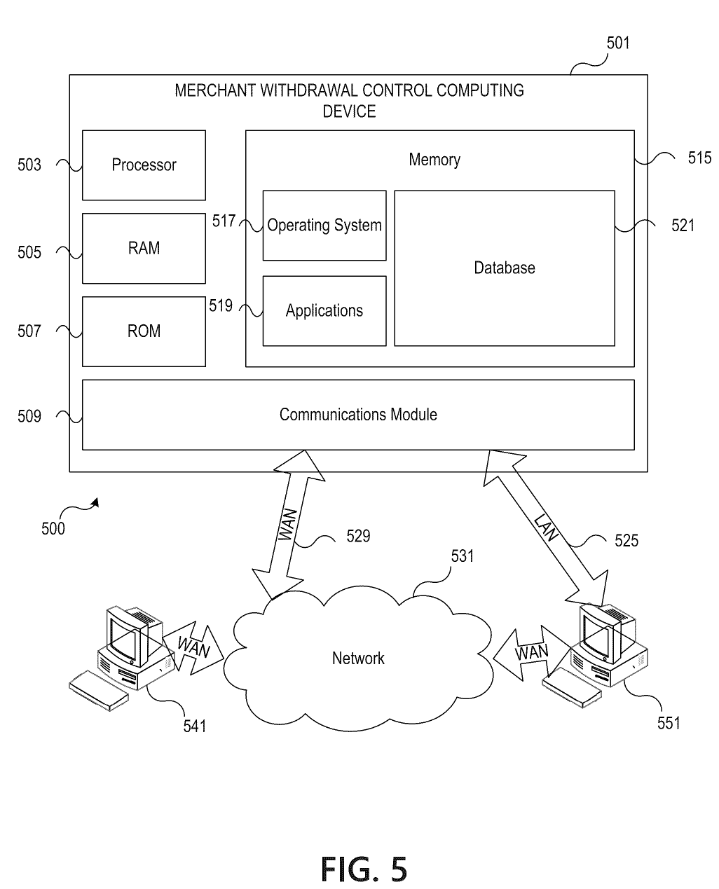

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include merchant withdrawal control computing device 501 having processor 503 for controlling overall operation of merchant withdrawal control computing device 501 and its associated components, including Random Access Memory (RAM) 505, Read-Only Memory (ROM) 507, communications module 509, and memory 515. Merchant withdrawal control computing device 501 may include a variety of computer readable media. Computer readable media may be any available media that may be accessed by merchant withdrawal control computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by merchant withdrawal control computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on merchant withdrawal control computing device 501. Such a processor may execute computer-executable instructions stored on a computer-readable medium.

Software may be stored within memory 515 and/or storage to provide instructions to processor 503 for enabling merchant withdrawal control computing device 501 to perform various functions as discussed herein. For example, memory 515 may store software used by merchant withdrawal control computing device 501, such as operating system 517, application programs 519, and associated database 521. Also, some or all of the computer executable instructions for merchant withdrawal control computing device 501 may be embodied in hardware or firmware. Although not shown, RAM 505 may include one or more applications representing the application data stored in RAM 505 while merchant withdrawal control computing device 501 is on and corresponding software applications (e.g., software tasks) are running on merchant withdrawal control computing device 501.

Communications module 509 may include a microphone, keypad, touch screen, and/or stylus through which a user of merchant withdrawal control computing device 501 may provide input, and may also include one or more of a speaker for providing audio output and a video display device for providing textual, audiovisual and/or graphical output. Computing system environment 500 may also include optical scanners (not shown).

Merchant withdrawal control computing device 501 may operate in a networked environment supporting connections to one or more remote computing devices, such as computing device 541 and 551. Computing devices 541 and 551 may be personal computing devices or servers that include any or all of the elements described above relative to merchant withdrawal control computing device 501.

The network connections depicted in FIG. 5 may include Local Area Network (LAN) 525 and Wide Area Network (WAN) 529, as well as other networks. When used in a LAN networking environment, merchant withdrawal control computing device 501 may be connected to LAN 525 through a network interface or adapter in communications module 509. When used in a WAN networking environment, merchant withdrawal control computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one FIG. may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, via an application executing on a user computing device, a request to withdraw an amount of funds from a user account;
execute an application programming interface (API) call to one or more merchant systems to determine availability of funds at one or more merchant locations;
receive, in response to the API call, funds availability from the one or more merchant systems;
generate a user interface displaying at least one merchant system of the one or more merchant systems, the at least one merchant system having sufficient funds available to provide the amount of funds requested in the request to withdraw the amount funds from the user account;
transmit, via the application and to the user computing device, the user interface, wherein transmitting the user interface causes the user interface to display on a display of the user computing device;
receive, via the application and from the user computing device, selection of the at least one merchant system of the one or more merchant systems;
generate a machine-readable code associated with the request to withdraw the amount of funds;
transmit, via the application and to the user computing device, the machine-readable code;
receive, from the at least one merchant system of the one or more merchant systems, an indication of a scan of the machine-readable code;
responsive to receiving the indication of the scan of the machine-readable code:
authorize and cause dispensing, by a merchant location associated with the at least one merchant system of the one or more merchant systems, the amount of funds to a user;
debit the amount of funds from the user account; and
update an account ledger associated with the user account based on the debit.

2. The computing platform of claim 1, further including instructions that, when executed, cause the computing platform to:
receive a settlement triggering event; and
responsive to receiving the settlement triggering event, transfer the amount of funds to a merchant account associated with the at least one merchant system of the one or more merchant systems.

3. The computing platform of claim 2, wherein the settlement triggering event includes one of: a close of business, a time of day, or completion of a user withdrawal.

4. The computing platform of claim 1, wherein the machine-readable code includes an indication of the amount of funds, a user identifier and a merchant identifier.

5. The computing platform of claim 1, wherein the application is a mobile banking application executing on the user computing device.

6. The computing platform of claim 1, further including instructions that, when executed, cause the computing platform to:
in response to receiving the selection of the at least one merchant system of the one or more merchant systems, and prior to debiting the amount of funds from the user account, flag the user account for an expected withdrawal.

7. The computing platform of claim 1, wherein the user interface further includes a location of the at least one merchant system.

8. A method, comprising:
receiving, by a computing platform, the computing platform having at least one processor, and memory, and via an application executing on a user computing device, a request to withdraw an amount of funds from a user account;
executing, by the at least one processor, an application programming interface (API) call to one or more merchant systems to determine availability of funds at one or more merchant locations;
receiving, by the at least one processor and in response to the API call, funds availability from the one or more merchant systems;
generating, by the at least one processor, a user interface displaying at least one merchant system of the one or more merchant systems, the at least one merchant system having sufficient funds available to provide the amount of funds requested in the request to withdraw the amount funds from the user account;
transmitting, by the at least one processor, via the application and to the user computing device, the user interface, wherein transmitting the user interface causes the user interface to display on a display of the user computing device;
receiving, by the at least one processor, via the application and from the user computing device, selection of the at least one merchant system of the one or more merchant systems;
generating, by the at least one processor, a machine-readable code associated with the request to withdraw the amount of funds;
transmitting, by the at least one processor, via the application and to the user computing device, the machine-readable code;
receiving, by the at least one processor and from the at least one merchant system of the one or more merchant systems, an indication of a scan of the machine-readable code;
responsive to receiving the indication of the scan of the machine-readable code:
authorizing and causing dispensing, by a merchant location associated with the at least one merchant system of the one or more merchant systems, the amount of funds to a user;
debiting, by the at least one processor, the amount of funds from the user account; and
updating, by the at least one processor, an account ledger associated with the user account based on the debit.

9. The method of claim 8, further including:
receiving, by the at least one processor, a settlement triggering event; and
responsive to receiving the settlement triggering event, transferring, by the at least one processor, the amount of funds to a merchant account associated with the at least one merchant system of the one or more merchant systems.

10. The method of claim 9, wherein the settlement triggering event includes one of: a close of business, a time of day, or completion of a user withdrawal.

11. The method of claim 8, wherein the machine-readable code includes an indication of the amount of funds, a user identifier and a merchant identifier.

12. The method of claim 8, wherein the application is a mobile banking application executing on the user computing device.

13. The method of claim 8, further including:
in response to receiving the selection of the at least one merchant system of the one or more merchant systems, and prior to debiting the amount of funds from the user account, flagging, by the at least one processor, the user account for an expected withdrawal.

14. The method of claim 8, wherein the user interface further includes a location of the at least one merchant system.

15. One or more non-transitory computer-readable media storing instructions that, when executed by a computing platform comprising at least one processor, memory, and a communication interface, cause the computing platform to:
receive, via an application executing on a user computing device, a request to withdraw an amount of funds from a user account;
execute an application programming interface (API) call to one or more merchant systems to determine availability of funds at one or more merchant locations;
receive, in response to the API call, funds availability from the one or more merchant systems;
generate a user interface displaying at least one merchant system of the one or more merchant systems, the at least one merchant system having sufficient funds available to provide the amount of funds requested in the request to withdraw the amount funds from the user account;
transmit, via the application and to the user computing device, the user interface, wherein transmitting the user interface causes the user interface to display on a display of the user computing device;
receive, via the application and from the user computing device, selection of the at least one merchant system of the one or more merchant systems;
generate a machine-readable code associated with the request to withdraw the amount of funds;
transmit, via the application and to the user computing device, the machine-readable code;
receive, from the at least one merchant system of the one or more merchant systems, an indication of a scan of the machine-readable code;
responsive to receiving the indication of the scan of the machine-readable code:
dispense, by a merchant location associated with the at least one merchant system of the one or more merchant systems, the amount of funds to a user;
debit the amount of funds from the user account; and
update an account ledger associated with the user account based on the debit.

16. The one or more non-transitory computer-readable media of claim 15, further including instructions that, when executed, cause the computing platform to:
receive a settlement triggering event; and
responsive to receiving the settlement triggering event, transfer the amount of funds to a merchant account associated with the at least one merchant system of the one or more merchant systems.

17. The one or more non-transitory computer-readable media of claim 16, wherein the settlement triggering event includes one of: a close of business, a time of day, or completion of a user withdrawal.

18. The one or more non-transitory computer-readable media of claim 15, wherein the machine-readable code includes an indication of the amount of funds, a user identifier and a merchant identifier.

19. The one or more non-transitory computer-readable media of claim 15, wherein the application is a mobile banking application executing on the user computing device.

20. The one or more non-transitory computer-readable media of claim 15, further including instructions that, when executed, cause the computing platform to:
in response to receiving the selection of the at least one merchant system of the one or more merchant systems, and prior to debiting the amount of funds from the user account, flag the user account for an expected withdrawal.

21. The one or more non-transitory computer-readable media of claim 15, wherein the user interface further includes a location of the at least one merchant system.
